(19) United States
(12) Patent Application Publication
(10) Pub. No.: US 2021/0368881 A1
(43) Pub. Date: Dec. 2, 2021

(54) RESPIRATOR MASK AND METHOD FOR MANUFACTURING

(71) Applicant: Dallas/Fort Worth International Airport Board, DFW Airport, TX (US)

(72) Inventor: Matthew L. Abbondanzio, Dallas, TX (US)

(21) Appl. No.: 17/303,298

(22) Filed: May 26, 2021

Related U.S. Application Data
(60) Provisional application No. 62/704,821, filed on May 29, 2020.

(51) Int. Cl. A41D 13/11; A62B 23/02

(52) U.S. Cl. CPC A41D 13/1176; A62B 23/025

(57) ABSTRACT

A mask that completely seals to the face of the wearer includes a filter material having a shape and size selected to cover a mouth and nose of the wearer. The mask also includes an adhesive ring disposed on one surface of the filter material at or near a circumferential edge of the filter material, the adhesive ring forming a closed loop around the circumferential edge of the filter material, the adhesive ring configured to removably adhere to a face of the wearer.

### CROSS-REFERENCE TO RELATED APPLICATION AND PRIORITY CLAIM

This application claims priority under 35 U.S.C. § 119(e) to U.S. Provisional Patent Application No. 62/704,821 filed on May 29, 2020 and entitled “RESPIRATOR MASK DEVICE,” the contents of which are hereby incorporated by reference in their entirety.

### TECHNICAL FIELD

This disclosure is generally directed to healthcare devices and more particularly to a respirator mask and a method for manufacturing such a respirator mask.

### BACKGROUND

A number of respirator mask designs exist but have multiple drawbacks. For example, current masks require a constant pressure to be exerted on the wearer's face by the surrounding portion of the mask or respirator, where the pressure is typically provided by an elastic band that extends around the wearer's head. Also, current masks feature complicated designs that use excess material. This leads to excess cost, making the masks unnecessarily expensive as well as over use of technical material that can be in short supply during events such as a pandemic or other supply chain interruptions.

### SUMMARY

This disclosure provides a respirator mask and a method for manufacturing such a respirator mask.

In one embodiment, the respirator mask includes a filter material having a shape and size selected to cover a mouth and nose of a wearer of the mask. The mask also includes an adhesive ring disposed on one surface of the filter material at or near a circumferential edge of the filter material, the adhesive ring forming a closed loop around the circumferential edge of the filter material, the adhesive ring configured to removably adhere to a face of the wearer.

In another embodiment, a method includes cutting a filter material from a sheet of respirator mask material such that the filter material has a shape and size selected to cover a mouth and a nose of a wearer of a mask. The method also includes cutting an adhesive ring from a sheet of adhesive material, the adhesive ring configured to removably adhere to a face of the wearer. The method further includes forming the mask by joining the adhesive ring to a surface of the filter material at or near a circumferential edge of the filter material, such that the adhesive ring forms a closed loop around the circumferential edge of the filter material.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates details of an example respirator mask according to this disclosure;

FIG. 2 illustrates an image of a person wearing the respirator mask of FIG. 1 according to this disclosure;

FIG. 3 illustrates details of an example adhesive ring that can be used in the respirator mask of FIG. 1 according to this disclosure; and

FIG. 4 illustrates a method for manufacturing a respirator mask according to this disclosure.

### DETAILED DESCRIPTION

The figures discussed below, and the various embodiments used to describe the principles of the present disclosure in this patent document are by way of illustration only and should not be construed in any way to limit the scope of this disclosure. Those skilled in the art will understand that the principles of the present disclosure may be implemented in any type of suitably arranged device or system.

For simplicity and clarity, some features and components are not explicitly shown in every figure, including those illustrated in connection with other figures. It will be understood that all features illustrated in the figures may be employed in any of the embodiments described. Omission of a feature or component from a particular figure is for purposes of simplicity and clarity and is not meant to imply that the feature or component cannot be employed in the embodiments described in connection with that figure. It will be understood that embodiments of this disclosure may include any one, more than one, or all of the features described here. Also, embodiments of this disclosure may additionally or alternatively include other features not listed here.

As known in the art, a respirator mask exhibits multiple features that distinguish the respirator mask from other protective masks. For example, the level of filtration of unwanted particles is generally higher (sometimes much higher) in a respirator mask than in a typical protective mask. Also, a respirator mask, when worn, usually exhibits a suitable seal around the mouth and nose, whereas other protective masks, when worn, may exhibit significant gaps between the skin and the mask, thus providing paths for unwanted particles.

As discussed above, many single use and even multi-use respirators (also sometimes referred to as masks or face coverings) have a number of drawbacks to their design. For example, current designs require a constant pressure to be exerted on the wearer's face by the surrounding portion of the mask or respirator. This is typically achieved using an elastic or mechanical band or tie that is attached to the respirator mask at a few points (typically four points) on the mask. These elastic bands or ties stretch or are wrapped around the back of the wearer's head. They either terminate in a knot or at the edges of the mask. One drawback to this design is the requirement of additional materials and attachment mechanisms. Another drawback is that the wearer has to be able to have the strap behind their head or around their ears and be comfortable with this. If the wearer is wearing a hat, oftentimes this requires the wearer to remove their head covering. In addition, this design often requires a fit check and air leak test in the case of a respirator. Any buckling in the mask edges or improper tension in the elastic or around the head wrap can cause the mask to leak air on exhale, inhale, or both. Whether it is a respirator or face covering, when a complete seal is made around the nose and mouth, the effectiveness of the device is dramatically improved. Gaps between the face and face covering create pathways for air to bypass the filtering mechanism rendering the device ineffective. With respect to a respirator, such a gap between the device and the nose and mouth disqualifies it as a respirator. Still another drawback of current mask designs is that most are oversized and cover large portions of the wearer's cheeks, neck, and other facial areas that are away from the mouth and nose. Many of these masks include multiple layers in order to provide backup filtration protection. This results in the usage of excess material to manufacture the mask. Excess material also results in excess costs in manufacturing.

To address these and other issues, embodiments of this disclosure provide a respirator mask where the mask is primarily comprised of only two simple components: 1) a filter material, and 2) an adhesive ring. As described below, the mask can be adhered to a person's face with the adhesive ring. This design allows for complete sealing around a person's face, which is an inherent requirement of any respirator. The mask is formed of inexpensive materials such that the mask can be used one time and thrown away. Benefits of the disclosed mask include cost reductions in manufacturing due to reduced labor and materials, and the ability to use a variety of filtration materials to provide different filtration levels based on customer needs and desired price points.

The disclosed respirator mask has a Bacterial Filtration Efficiency (BFE) or Particle Filtration Efficiency (PFE) rating of 95 or better. In addition, depending on the material utilized in manufacturing, the mask can meet or exceed the National Institute for Occupational Safety and Health (NIOSH) standard of N95 or better. Better is defined as having a particulate filtration rating of higher than 95 up to 100 as well as having an “N”, “R” or “P” oil resistance rating. Here, “N” indicates not resistant to oil, “R” indicates resistant, and “P” indicates oil proof.

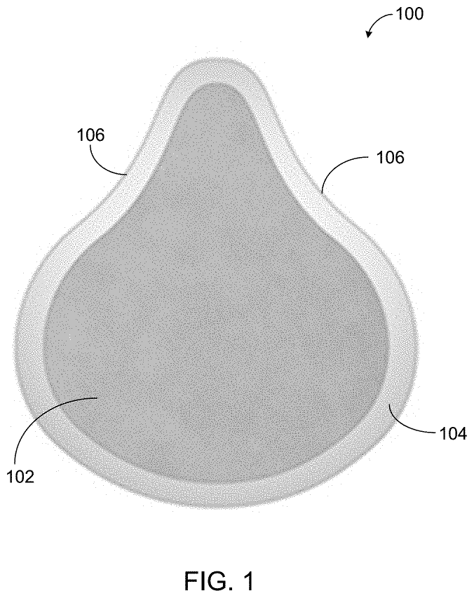

FIG. 1 illustrates details of an example respirator mask 100 according to this disclosure. The embodiment of the respirator mask 100 shown in FIG. 1 is for illustration only. Other embodiments of the respirator mask 100 could be used without departing from the scope of this disclosure.

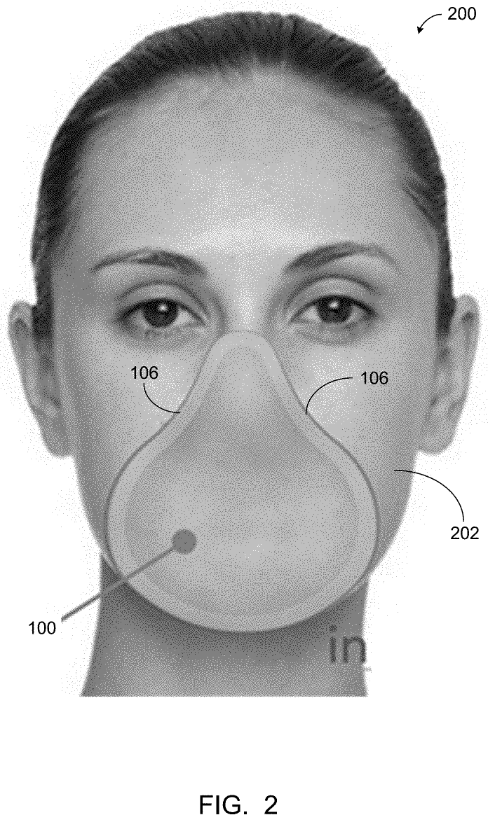

As shown in FIG. 1, the respirator mask 100 is formed of a filter material 102 that may be of any suitable shape and size that allows for the mask 100 to cover the wearer's mouth and nose. The respirator mask 100 has an overall shape selected to promote an easy adherence to the skin of the wearer along the nose, cheeks, and down to (or under) the chin. In some embodiments, the respirator mask 100 has an overall shape comprised primarily of convex curves. However, the respirator mask 100 can exhibit concave sections 106 provided for correct contouring between the wearer's nose and cheeks. For example, FIG. 2 illustrates an image of a person 200 wearing the respirator mask 100 according to this disclosure. As shown in FIG. 2, the mask 100 is worn over the lower portion of the face 202 of the person 200. The concave sections 106 provide an improved fit of the mask 100 by enabling the mask 100 to follow the contours of the face 202 from the bridge of the nose down to the cheek.

In some embodiments, the filter material 102 is formed of one or more materials that enable the mask 100 to have a BFE or PFE rating of 95 or better, and meet or exceed the NIOSH standard of N95 or better. In other embodiments where the mask 100 is not respirator-rated, the filter material 102 may have a rating less than a BFE or PFE rating 95 and/or not meet the NIOSH N95 standard. In some embodiments, the filter material 102 may be die cut from a flat sheet. The filter material 102 may be of any suitable thickness as long as the filter material 102 provides the necessary respiration and filtration capabilities for those embodiments that need to have a BFE or PFE rating of 95 or better, and meet or exceed the NIOSH standard of N95. In some embodiments, the filter material 102 may include pleats that allow for further expansion of the filter material 102 to allow for ease of speaking while wearing the respirator mask 100. The pleats can be formed in the filter material 102 using any suitable fabrication technique, including, e.g., heat seal bonding of the filter material 102, glue, stitching, adhesive, and the like.

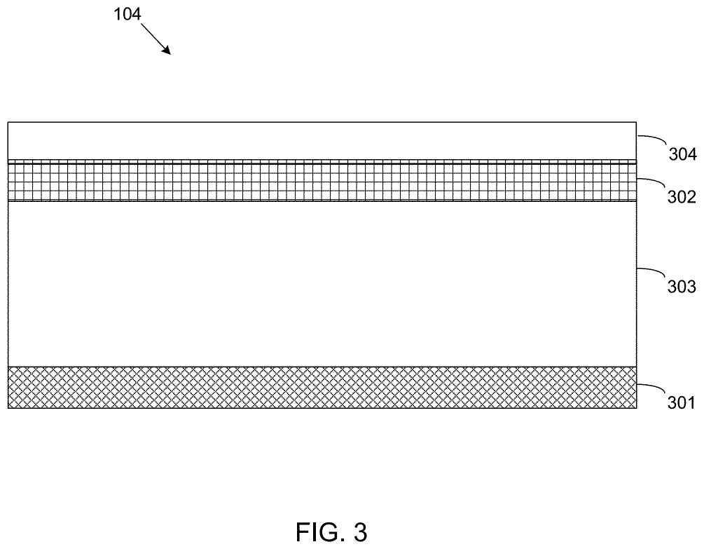

As shown in FIG. 1, the respirator mask 100 also includes an adhesive ring 104 that extends completely around the mask 100 at or near a circumferential edge. The adhesive ring 104 includes double sided adhesive in order to be able to bond securely to the filter material 102 and also bond to the wearer's skin. This creates a seal between the wearer's respiratory system and the environment that matches or exceeds the filtration specification of the filter material 102. For example, if the filter material 102 has a NIOSH N95 rating, then the adhesive ring 104 is selected to have an adhesive type, adhesive thickness, and adhesive width so as to create a seal between the skin and the filter material 102 that is at least at a level of NIOSH N95. In some embodiments, the adhesive ring 104 is formed as a closed loop having a shape that generally corresponds to the outer edge of the filter material 102, such as shown in FIG. 1. The adhesive ring 104 may be approximately 1 cm wide, although other widths are possible and within the scope of this disclosure. The adhesive ring 104 may be comprised of one adhesive layer or of two or more layers formed together. For example, the adhesive ring 104 may include a pliable cushion layer with adhesive layers formed on opposite surfaces of the cushion layer. Further details of example embodiments of the adhesive ring 104 are provided below in conjunction with FIG. 3.

The outer surface of the adhesive ring 104 can be covered with a release liner to avoid the mask 100 from sticking to objects before use. In operation, the wearer removes the release liner from the adhesive ring 104 and then adheres the mask 100 to the face, as shown in FIG. 2. The adhesive ring 104 forms a suitable seal between the wearer's face and the mask 100, while still allowing for movement of the wearer's mouth (e.g., for speaking or breathing). In some embodiments, when putting on the mask 100, it may be helpful for the wearer to open their mouth to create a larger facial area to cover with the mask 100. This provides additional freedom of movement when the mask 100 is in place. If the mask 100 is applied to a closed mouth, then later movement of the jaw (either lateral or up and down) may tend to pull on the mask 100 and possibly break the seal between the skin and the mask 100.

Although FIG. 1 depicts one example of a respirator mask 100, various changes may be made to FIG. 1. For example, while the respirator mask 100 is depicted as having a roughly pear shape, the respirator mask 100 could include other shapes, such as a circle, oval, or other amorphous shape. Also, the respirator mask 100 may include any number of each component shown. In addition, components may be deleted or arranged in a different order, and additional components may be added according to particular needs.

FIG. 3 illustrates additional details of the adhesive ring 104 for use in the respirator mask 100 according to this disclosure. The embodiment of the adhesive ring 104 shown in FIG. 3 is for illustration only. Other embodiments of the adhesive ring 104 could be used without departing from the scope of this disclosure.

In FIG. 3, the adhesive ring 104 is shown in a cross-sectional view. The adhesive ring 104 comprises three layers 301-303. For clarity of illustration, the thickness of each layer 301-303 may not be drawn to scale. The layer 301 is a first adhesive layer that bonds to the inside surface of the filter material 102 of the mask 100. In some embodiments, the layer 301 is formed of polypropylene, silicone, polyorganosiloxane, or another suitable material or materials. The layer 302 is a second adhesive layer that bonds to the skin. This adhesive may be similar to other medical-use adhesives, such as those for securing an intravenous (IV) line to the skin. The layer 303 is a carrier layer between the first layer 301 and the second layer 302. In some embodiments, the carrier layer 303 has a greater thickness than the adhesive layers 301-302 and may be relatively soft and pliable to promote easy application to various contours on the face of the wearer. In some embodiments, the thickness of the carrier layer 303 is approximately 2 mm, although other thicknesses are possible and within the scope of this disclosure.

As discussed above, the adhesive ring 104 also includes a release liner 304 disposed over the adhesive layer 302. The release liner 304 protects the sticky surface of the adhesive layer 302 and keeps the mask 100 from sticking to objects before use. In operation, the wearer removes the release liner 304 from the adhesive ring 104 before adhering the mask 100 to the face. In some embodiments, there are one or more breaks or separations in the loop shape of the release liner 304 to allow the wearer to easily grab an end of the release liner 304 in order to pull the release liner 304 off the adhesive ring 104. In some embodiments, the release liner 304 is formed of a paper or plastic material that easily separates from the adhesive layer 302.

Although FIG. 3 depicts one example of the adhesive ring 104, various changes may be made to FIG. 3. For example, while shown composed of three layers, the adhesive ring 104 may include more or fewer than three layers. One or more of the layers 301-303 shown in FIG. 3 may be removed, repeated, or arranged in a different order. Each layer 301-303 may be thicker or thinner than depicted in FIG. 3. Each layer 301-303 may include one or more sub-layers. Other layers, composed of the same or different materials, may be added to the adhesive ring 104.

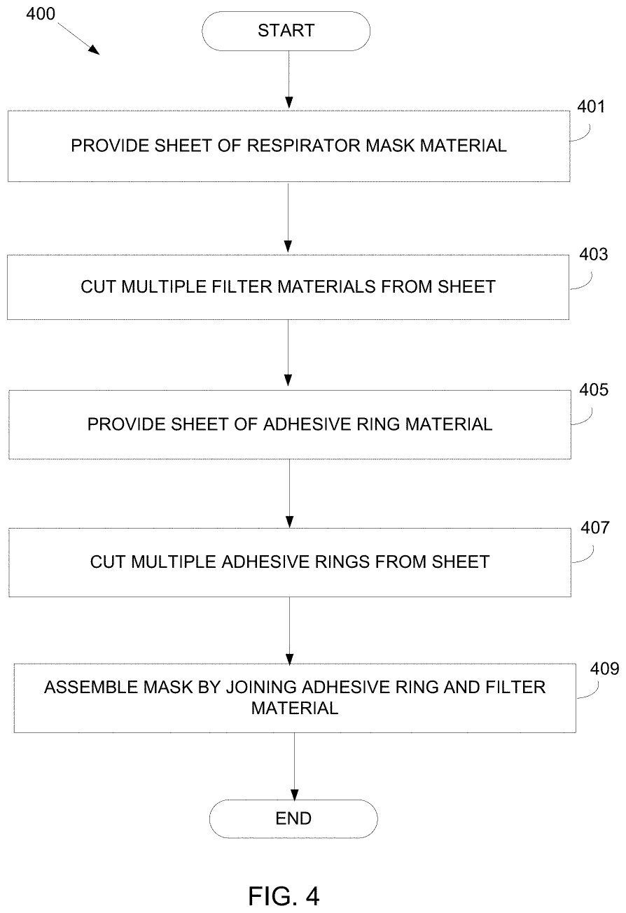

FIG. 4 depicts an example method 400 for manufacturing a respirator mask according to this disclosure. For ease of explanation, the method 400 may be described as being performed using the respirator mask 100 of FIG. 1. However, the method 400 may involve the use of any other suitable mask(s). The method 400 as shown in FIG. 4 is for illustration only. Other embodiments of the method 400 could be used without departing from the scope of this disclosure.

As shown in FIG. 4, a sheet of respirator mask material is provided at step 401. This may include, for example, providing a sheet formed of the same material as the filter material 102. Multiple filter materials 102 having a final shape corresponding to a respirator mask 100 are cut (e.g., die cut) from the sheet of respirator mask material at step 403. A sheet of adhesive ring material is provided at step 405. This may include, for example, providing a sheet formed of the same layers 301-304 as the adhesive ring 104. Multiple adhesive rings 104 having a final shape are cut from the sheet of adhesive ring material at step 407. Multiple respirator masks 100 are assembled at step 409 by aligning each adhesive ring 104 with the outer edge of a corresponding filter material 102, and joining the adhesive ring 104 to the filter material 102 using the adhesive layer 301. Each assembled respirator mask 100 is the same as shown in FIG. 1.

Although FIG. 4 illustrates one example of a method for manufacturing a respirator mask according to this disclosure, various changes may be made to FIG. 4. For example, while shown as a series of steps, various steps in FIG. 4 may overlap, occur in parallel, occur in a different order, or occur multiple times.

Another example method for manufacturing a respirator mask may include a continuous roll-to-roll process wherein the filter material starts in the form of a roll or web having a width no less than the width of the mask. The filter material is fed through a continuous or discontinuous feeding mechanism where the adhesive ring material may or may not also start. As a roll, the adhesive ring material is cut to single or multiple shapes that when combined form the circumferential ring and is then applied to the filter material. This web of filter material with adhesive applied to it is then cut to shape with a roll or punch die cutter, laser, or the like. The order of this process may be changed to allow for various cost effective manufacturing methods.

It may be advantageous to set forth definitions of certain words and phrases used throughout this patent document. The terms “transmit” and “receive,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A mask comprising:
a filter material having a shape and size selected to cover a mouth and a nose of a wearer of the mask; and
an adhesive ring disposed on one surface of the filter material at or near a circumferential edge of the filter material, the adhesive ring forming a closed loop around the circumferential edge of the filter material, the adhesive ring configured to removably adhere to a face of the wearer.

2. The mask of claim 1, wherein the filter material is selected such that the mask has a Bacterial Filtration Efficiency (BFE) or Particle Filtration Efficiency (PFE) rating of 95 or better, and meets or exceeds a National Institute for Occupational Safety and Health (NIOSH) standard of N95 or better.

3. The mask of claim 1, wherein the mask does not include a band or tie that is configured to extend around a head of the wearer.

4. The mask of claim 1, wherein the shape of the filter material includes multiple concave sections that correspond to the nose and cheeks of the wearer.

5. The mask of claim 1, wherein the adhesive ring comprises:
a first adhesive layer configured to bond to an inside surface of the filter material;
a second adhesive layer configured to bond to skin of the wearer; and
a carrier layer disposed between the first adhesive layer and the second adhesive layer.

6. The mask of claim 5, wherein the first adhesive layer is formed of at least one of polypropylene, silicone, and polyorganosiloxane.

7. The mask of claim 5, wherein the carrier layer is a pliable cushion layer.

8. The mask of claim 5, wherein the carrier layer is thicker than the first adhesive layer and the second adhesive layer.

9. The mask of claim 5, wherein the adhesive ring further comprises:
a release liner disposed over the second adhesive layer.

10. The mask of claim 9, wherein the release liner includes one or more breaks in a loop shape of the release liner.

11. A method comprising:
cutting a filter material from a sheet of respirator mask material such that the filter material has a shape and size selected to cover a mouth and a nose of a wearer of a mask;
cutting an adhesive ring from a sheet of adhesive ring material, the adhesive ring configured to removably adhere to a face of the wearer; and
forming the mask by joining the adhesive ring to a surface of the filter material at or near a circumferential edge of the filter material, such that the adhesive ring forms a closed loop around the circumferential edge of the filter material.

12. The method of claim 11, wherein the filter material is selected such that the mask has a Bacterial Filtration Efficiency (BFE) or Particle Filtration Efficiency (PFE) rating of 95 or better, and meets or exceeds a National Institute for Occupational Safety and Health (NIOSH) standard of N95 or better.

13. The method of claim 11, wherein the mask does not include a band or tie that is configured to extend around a head of the wearer.

14. The method of claim 11, wherein the shape of the filter material includes multiple concave sections that correspond to the nose and cheeks of the wearer.

15. The method of claim 11, wherein the adhesive ring comprises:
a first adhesive layer configured to bond to an inside surface of the filter material;
a second adhesive layer configured to bond to skin of the wearer; and
a carrier layer disposed between the first adhesive layer and the second adhesive layer.

16. The method of claim 15, wherein the first adhesive layer is formed of at least one of polypropylene, silicone, and polyorganosiloxane.

17. The method of claim 15, wherein the carrier layer is a pliable cushion layer.

18. The method of claim 15, wherein the carrier layer is thicker than the first adhesive layer and the second adhesive layer.

19. The method of claim 15, wherein the adhesive ring further comprises:
a release liner disposed over the second adhesive layer.

20. The method of claim 19, wherein the release liner includes one or more breaks in a loop shape of the release liner.
